(19) United States
(12) Patent Application Publication
(10) Pub. No.: US 2007/0069870 A1
(43) Pub. Date: Mar. 29, 2007

(54) Vehicle intruder alert system

(76) Inventor: Gary Strumolo, Beverly Hills, MI (US)

Correspondence Address: RICHARD M. SHARKANSKY, PO BOX 557, MASHPEE, MA, 02649, US

(21) Appl. No.: 11/237,348

(22) Filed: Sep. 28, 2005

(51) Int. Cl. B60R 25/10

(52) U.S. Cl. 340/426.1

(57) ABSTRACT

A method and system for indicating that an intruder has entered a vehicle. The method includes placing a flag in a processor included in the vehicle in a set condition when an operator of the vehicle has left the vehicle. The flag is placed in a reset condition in response to detection that the vehicle has been entered without proper activation of a keyless entry system assigned to the vehicle. The method detects proper activation of the keyless entry system assigned to the vehicle. The method activates an intruder indicator in response to the detection of the proper keyless entry system activation if the flag has been placed in the reset condition whereas, if the flag has been placed in the set condition, allowing entry to the vehicle without activating the intruder indicator in response to the detection of the proper keyless entry system activation.

### TECHNICAL FIELD

This invention relates generally to vehicle intruder alert systems.

### BACKGROUND AND SUMMARY

As is known in the art, it would be desirable to provide an indication when an intruder has entered a vehicle. Many such systems have been suggested and are relatively complex and hence expensive. I have discovered a very simple and inexpensive intruder alert system that uses devices and process which are for the most part presently available on most existing vehicles.

In accordance with the invention, a method is provided for indicating that an intruder has entered a vehicle. The method includes setting a condition in response to an indication that the vehicle has been entered without proper activation of a keyless entry system assigned to the vehicle; detecting proper activation of the keyless entry system assigned to the vehicle; and activating an intruder indicator in response to the detection of the proper keyless entry system activation if the condition has been set, whereas, in the absence of such condition being set, allowing entry to the vehicle without activating the intruder indicator in response to the detection of the proper keyless entry system activation.

In one embodiment, a method is provides for indicating that an intruder has entered a vehicle. The method includes placing a flag in a processor included in the vehicle in a set condition when an operator of the vehicle has left the vehicle. The flag is placed in a reset condition in response to detection that the vehicle has been entered without proper activation of a keyless entry system assigned to the vehicle. The method detects proper activation of the keyless entry system assigned to the vehicle. The method activates an intruder indicator in response to the detection of the proper keyless entry system activation if the flag has been placed in the reset condition whereas, if the flag has been placed in the set condition, allowing entry to the vehicle without activating the intruder indicator in response to the detection of the proper keyless entry system activation.

With such method, because most vehicles today include engine control units having processors and also include keyless entry systems and door switches which become activated upon opening and closing vehicle doors to thereby indicate entry into the vehicle, I have discovered a very simple and inexpensive intruder alert system that uses devices and process which are for the most part presently available on most existing vehicles.

In accordance with one embodiment, a system is provided for indicating that an intruder has entered a vehicle. The system includes: a detector on the vehicle for detecting that the operator of the vehicle has left the vehicle; an intruder indicator; a keyless entry system association with the vehicle; and a processor in the vehicle. The processor is programmed to: have a flag therein placed in a set condition in response to the detector detecting that the operator of the vehicle has left the vehicle; have the flag placed in a reset condition in response to an indication that the vehicle has been entered without proper activation of the keyless entry system assigned to the vehicle; and activate the intruder indicator in response to the detection of the keyless entry system activation if the flag has been placed in the reset condition whereas, if the flag has been placed in the set condition, allowing entry to the vehicle without activating the intruder indicator in response to the detection of the proper keyless entry system activation.

In one embodiment, the keyless entry system includes a transmitter and a receiver.

In one embodiment, the transmitter includes a fob.

In one embodiment, an article of manufacture, comprising: a computer storage medium having a computer program encoded therein for providing an indication that an intruder has entered a vehicle. The computer storage medium comprises: code for placing a flag in a processor included in the vehicle in a set condition when an operator of the vehicle has left the vehicle; code for placing the flag in a reset condition in response to an indication that the vehicle has been entered without proper activation of a keyless entry system assigned to the vehicle; and code for activate the intruder indicator in response to the detection of the keyless entry system activation if the flag has been placed in the reset condition whereas, if the flag has been placed in the set condition, allowing entry to the vehicle without activating the intruder.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a vehicle intruder alert systems according to the invention; and

FIG. 2 is a flow diagram of a method for providing intruder alert for the vehicle in FIG. 1 according to the invention.

Like reference symbols in the various drawings indicate like elements.

### DETAILED DESCRIPTION

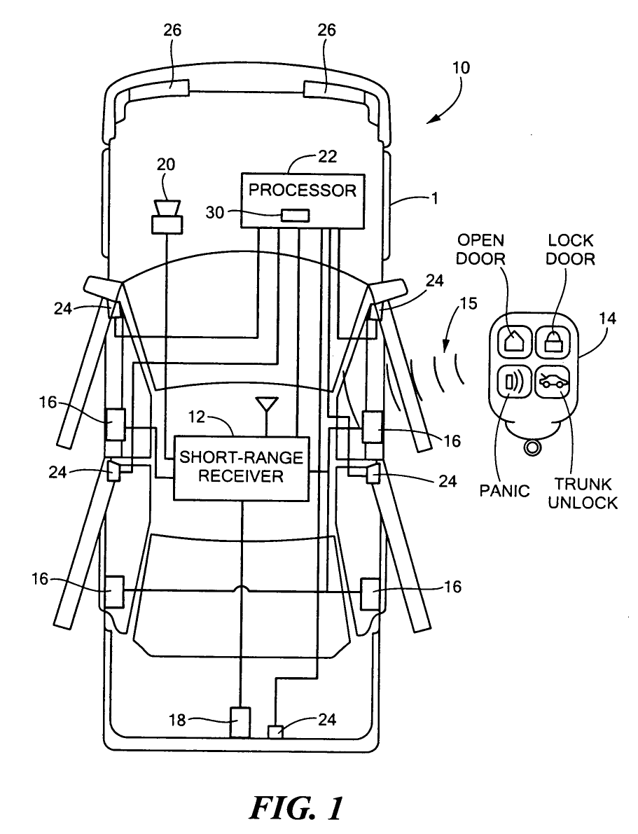

Referring now to FIG. 1 is a block diagram of a vehicle 1 having the remote keyless entry system 10 is shown. The vehicle 1 is equipped with a short-range wireless receiver 12 that is capable of receiving normal short-range signals from a wireless handheld transmitter 14 that is typically carried by the user, such as a key fob. The range of the handheld transmitter 14 is typically 10-20 meters and controls several functions that include, but are not limited to, lock, unlock, trunk control, panic alarm activation and deactivation, and remote start. Other functions too numerous to mention herein are also capable of being controlled by the remote system and one skilled in the art is aware of the nearly limitless possibilities. Here, the transmitter 14 is shown to have a “door open” button, a “trunk open” button, a “door lock: button and a “panic” alarm button.

The short-range receiver 12 is typically hard wired to each function that it is designed to control. For example, in FIG. 1, the short-range receiver 12 is hard wired to the door locks 16, the trunk lock, 18 and the vehicles horn 20.

The handheld transmitter 14 is typically and RF transmitter that is capable of broadcasting at 315 MHz with a predefined protocol 15. The broadcast signals are typically coded or encrypted in order to identify the broadcast signal with the particular vehicle and particular vehicle function being controlled. The broadcast signals are transmitted to the short-range receiver 12, where the commands are executed. Up to this point, this is typical of a remote keyless entry system already known in the art. Thus, as noted above, the short-range receiver 12 is typically hard wired to each function that it is designed to control. For example, in FIG. 1, the short-range receiver 12 is hard wired to the door locks 16, the trunk lock, 18 and the vehicles horn 20. The signals produced by the short-range receiver are processed by the processor 22.

The vehicle 1 also includes an engine control unit (ECU) having a digital processor 22. The vehicle 1 also includes buttons 24 for indicating when a door or trunk has is opened. As is known, such buttons 24 are used to activate an interior light, not shown, or to indicate to the processor 22 that a door is in an open condition or that the trunk is in an open condition to the operator.

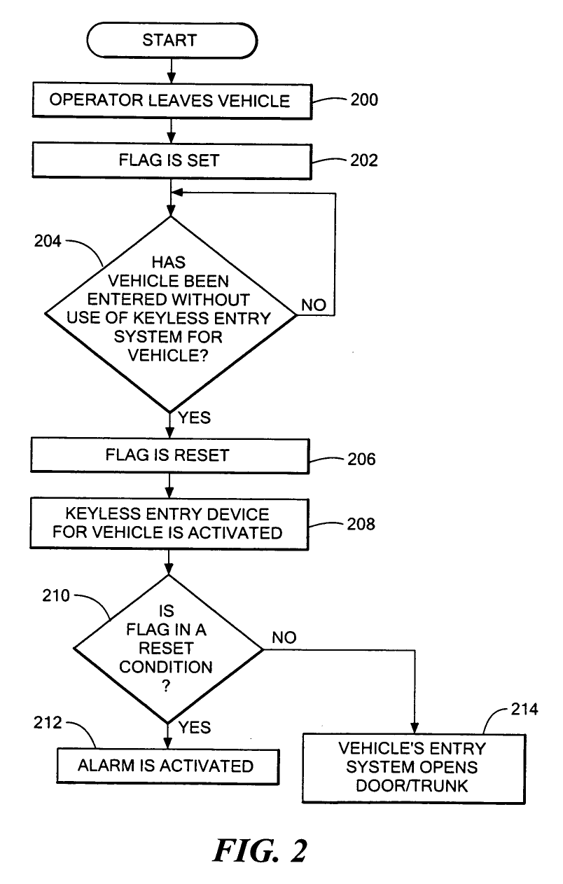

Thus, as will be described in more detail below, the keyless entry system having the transmitter 14 and receiver 12, the buttons 24, the horn 20, and the processor 22 programmed in accordance with the flow diagram to be described in connection with FIG. 2, provide a system for providing an indication that an intruder has entered the vehicle 1. The detection by receiver 12 of the activation of the door lock button on transmitter 14 serves as a detector on the vehicle for detecting that the operator of the vehicle has left the vehicle 1. Other such detectors may be provided such as by having the processor 22 determines whether the engine has been turned off for a predetermined period of time after one of the door indicator buttons 24 has been activated. The horn 20 serves as an intruder indicator; however the vehicle lights 26 and/or horn 20 may serve as the intruder indicator.

The processor 22 includes a computer storage medium, such as a read only memory (ROM) 30, for example, programmed to: (a) have a flag therein placed in a set condition in response to the detector detecting that the operator of the vehicle has left the vehicle, through in this example, as noted above, the detection by receiver 12 of the activation of the door lock button on transmitter 14; (b) have the flag placed in a reset condition in response to an indication that the vehicle has been entered without proper activation of the keyless entry system assigned to the vehicle as by detection of activation of one of the door or trunk button 24 without detection by receiver 12 of the activation of the door lock button on transmitter 14; and (c) activate the intruder indicator, here for example, horn 20, in response to the detection of the keyless entry system activation if the flag has been placed in the reset condition whereas, if the flag has been placed in the set condition, allowing entry to the vehicle; e.g., de-activation of the door locks 16 without activating the intruder indicator in response to the detection of the proper keyless entry system activation.

Referring now to FIG. 2 a flow diagram is shown of the program used to the processor 22 and stored in ROM 30. The processor 22 receives signals from the buttons 24 and the short-range receiver 12. In Step 200, the process detects that the operator has left the vehicle. As noted above, this may be performed by the operator pressing the door lock button on the transmitter 14 or by having the processor 22 determines whether the engine has been turned off for a predetermined period of time after one of the door indicator buttons 24 has been activated.

In Step 202, a flag in the processor 22 is placed in a set condition.

In Step 204, the processor 22 determines whether the vehicle has been entered without the use of the keyless entry system. For example, the processor 22 determines that one of the door or trunk buttons 24 has been activated without activation of the open button on the transmitter 14 without use of the keyless entry system, the flag is placed by the processor 22 in the reset condition, Step 206; otherwise the process returns to Step 204.

In Step 208, the processor 22 detects proper keyless transmission to the assigned vehicle, e.g., the receiver 12 detects that the transmitter 14 “door open” or “trunk open” button has been pressed and the proper code for this vehicle has also been transmitted.

Next, in Step 210, the processor 22 determines whether the flag has been placed in the reset condition. If the flag has been placed in the reset condition, the alarm, here horn 20, for example, is activated. If, on the other hand, the flag has not been placed in the reset condition (i.e., the flag is in the set condition), the door or trunk, as the case may be, is opened

A number of embodiments of the invention have been described. Nevertheless, it will be understood that various modifications may be made without departing from the spirit and scope of the invention. For example, while here the intruder detection system is shown for a vehicle such as a car or truck or compartment thereof, such as the trunk in the case of a car, the system and method may be used to detect intrusion into any area, such as a home, room secured through a keyless entry system. Further, the keyless entry system need not include a fob type transmitter but may be any other wireless system or may be a wired touch pad system mounted to a door of the vehicle and requiring the entry of a proper code into the keypad, such code having been assigned to the vehicle. Accordingly, other embodiments are within the scope of the following claims.

What is claimed is:

1. A method for providing an indication that an intruder has entered a vehicle, comprising:
setting a condition in response to an indication that the vehicle has been entered without proper activation of a keyless entry system assigned to the vehicle;
detecting proper activation of the keyless entry system assigned to the vehicle;
activating an intruder indicator in response to the detection of the proper keyless entry system activation if the condition has been set, whereas, in the absence of such condition being set, allowing entry to the vehicle without activating the intruder indicator in response to the detection of the proper keyless entry system activation.

2. A method for providing an indication that an intruder has entered a vehicle, comprising:
placing a flag in a processor included in the vehicle in a set condition when an operator of the vehicle has left the vehicle;
placing the flag in a reset condition in response to an indication that the vehicle has been entered without proper activation of a keyless entry system assigned to the vehicle;
detecting proper activation of the keyless entry system assigned to the vehicle;
activating an intruder indicator in response to the detection of the proper keyless entry system activation if the flag has been placed in the reset condition whereas, if the flag has been placed in the set condition, allowing entry to the vehicle without activating the intruder indicator in response to the detection of the proper keyless entry system activation.

3. A system for providing an indication that an intruder has entered a vehicle, comprising:
a detector on the vehicle for detecting that the operator of the vehicle has left the vehicle;
an intruder indicator;
a keyless entry system association with the vehicle;
a processor in the vehicle programmed to:
have a flag therein placed in a set condition in response to the detector detecting that the operator of the vehicle has left the vehicle;
have the flag placed in a reset condition in response to an indication that the vehicle has been entered without proper activation of the keyless entry system assigned to the vehicle; and
activate the intruder indicator in response to the detection of the keyless entry system activation if the flag has been placed in the reset condition whereas, if the flag has been placed in the set condition, allowing entry to the vehicle without activating the intruder indicator in response to the detection of the proper keyless entry system activation.

4. The system recited in claim 3 wherein the keyless entry system includes a transmitter and a receiver.

5. The system recited in claim 4 wherein the transmitter includes a fob.

6. An article of manufacture, comprising:
a computer storage medium having a computer program encoded therein for providing an indication that an intruder has entered a vehicle, said computer storage medium comprising:
code for placing a flag in a processor included in the vehicle in a set condition when an operator of the vehicle has left the vehicle;
code for placing the flag in a reset condition in response to an indication that the vehicle has been entered without proper activation of a keyless entry system assigned to the vehicle;
code for activate the intruder indicator in response to the detection of the keyless entry system activation if the flag has been placed in the reset condition whereas, if the flag has been placed in the set condition, allowing entry to the vehicle without activating the intruder.
